(19) United States
(12) Patent Application Publication
(10) Pub. No.: US 2026/0098412 A1
(43) Pub. Date: Apr. 9, 2026

(54) DECORATIVE PANEL

(71) Applicant: UNILIN, BV, Wielsbeke (BE)

(72) Inventors: Benjamin CLEMENT, Waregem (BE); Sam LEDEGEN, Gent (BE)

(21) Appl. No.: 19/114,898

(22) PCT Filed: Sep. 26, 2023
(86) PCT No.: PCT/IB2023/059492

§ 371 Date: Mar. 25, 2025

(30) Foreign Application Priority Data
Oct. 6, 2022 (BE) 2022/5799

(51) Int. Cl. E04F 15/10; B32B 21/02; B32B 21/06; E04F 15/20

(52) U.S. Cl. CPC E04F 15/107; B32B 21/02; B32B 21/06; E04F 15/102; E04F 15/206; B32B 2250/04; B32B 2260/026; B32B 2260/028; B32B 2260/046; B32B 2264/065; B32B 2264/067; B32B 2264/303; B32B 2307/72; B32B 2307/7376

(57) ABSTRACT

A decorative panel includes a decorative top layer, an intermediate layer and a carrier layer. The intermediate layer is located between the decorative top layer and the carrier layer. The intermediate layer includes wood particles, low-density particles and a polymer binder. The low-density particles have a density of less than 0.35 g/cm3. The polymer binder binds the wood particles and the low-density particles in the intermediate layer.

The invention relates to decorative panels that comprise a decorative top layer and a carrier layer. Such decorative panels can be used for example as floor panels.

WO97/47834 describes such a floor panel. WO97/47834 describes laminated floor panels that comprise a wood-based substrate. This wood-based substrate can be a fibreboard.

A drawback of existing floor panels is that they produce noise when walked on.

An object of the invention is therefore to provide floor panels that produce less noise when walked on.

The first aspect of the invention relates to a decorative panel, wherein the decorative panel comprises a decorative top layer and a carrier layer. The decorative panel of the first aspect of the invention is characterized in that the panel comprises an intermediate layer; wherein the intermediate layer is located between the decorative top layer and the carrier layer; wherein the intermediate layer comprises wood particles, low-density particles and a polymer binder; wherein the low-density particles have a density of less than 0.35 g/cm³, wherein the polymer binder binds the wood particles and the low-density particles in the intermediate layer.

The presence of the intermediate layer with its specific composition ensures that less noise is generated when such panels are walked on when used as floor panels. A further advantage is that in producing the decorative panel, the decorative surface can be provided with a deeper texture, because a texture can easily be pressed into the intermediate layer.

The invention also allows sufficiently high impact resistance of the decorative panel to be obtained, because in addition to low-density particles, the intermediate layer also comprises wood particles.

The use of low-density particles allows waste products or recycled material to be used. This contributes to a circular economy.

The wood particles can be wood chips and/or wood fibres.

A preferred embodiment of the first aspect of the invention is characterized in that the low-density particles have a density of less than 0.30 g/cm³. Such embodiments ensure even better sound dampening.

A preferred embodiment of the first aspect of the invention is characterized in that the low-density particles are selected from one or more of cork particles, polyurethane foam particles, thermoplastic foam particles or expanded glass. Expanded glass is available for example under the brand name Poraver.

A preferred embodiment of the first aspect of the invention is characterized in that the intermediate layer comprises between 5 and 25% by weight—and preferably between 7.5 and 15% by weight—of low-density particles. These embodiments are advantageous in that optimum properties are achieved. In addition to favourable sound dampening, the decorative panel also shows sufficient resistance to impact loading.

A preferred embodiment of the first aspect of the invention is characterized in that the low-density particles have an apparent diameter of less than 2.5 mm, and preferably less than 2 mm. “Apparent diameter” refers to the diameter of a spherical shape that has the same volume as a particle not necessarily having a spherical shape. Such embodiments are advantageous in that good sound dampening is combined with good impact resistance of the decorative panel.

A preferred embodiment of the first aspect of the invention is characterized in that the thickness of the intermediate layer is between 5 and 40% of the total thickness of the panel. More preferably, the thickness of the intermediate layer is between 10 and 30% of the total thickness of the panel.

Such embodiments ensure optimum properties of the decorative panel, both with respect to mechanical properties and with respect to sound dampening.

A preferred embodiment of the first aspect of the invention is characterized in that the polymer binder is a thermoplastic binder, preferably wherein the thermoplastic binder accounts for at least 20% by weight—and preferably at least 25% by weight—of the intermediate layer. For example, the thermoplastic binder accounts for 30% by weight of the intermediate layer.

The use of a thermoplastic binder in the intermediate layer ensures even better sound dampening when a floor covering composed of such decorative panels is walked on.

More preferably, the thermoplastic binder of the intermediate layer is selected from polyvinyl butyral (PVB), polylactic acid (PLA) and ethylene vinyl acetate (EVA).

These thermoplastic binders ensure even better sound dampening. The use of these thermoplastic binders also ensures increased water resistance of the decorative panel.

The use of polyvinyl butyral (PVB) is advantageous in that polyvinyl butyral (PVB) can be used from windscreens of automobiles that have reached the end of their useful life. The use of polyvinyl butyral (PVB) therefore contributes to a circular economy.

A preferred embodiment of the first aspect of the invention is characterized in that the intermediate layer, in addition to a thermoplastic binder, also comprises a thermosetting binder, preferably selected from polyurethane, melamine formaldehyde, methylene diphenyl diisocyanate, urea formaldehyde and melamine urea formaldehyde.

Such embodiments ensure an improved impact resistance of the decorative panels. The use of the thermosetting binder also ensures that there is less or no tendency of the intermediate layer to adhere to the processing equipment because of the thermoplastic binder. Specifically, adhesion to the continuous band on which the materials that together form the intermediate layer are scattered is prevented.

The use of a thermosetting binder is also advantageous for the adhesion of the decorative top layer to the intermediate layer. This is particularly important when the decorative top layer is laminated onto the intermediate layer using thermosetting resins (for example using melamine formaldehyde resin).

Polyurethane is preferred as the thermosetting binder in the intermediate layer because of the even better sound dampening of such decorative panels.

Preferably, the thermosetting binder accounts for between 3 and 12% by weight—and more preferably between 4 and 10% by weight—of the intermediate layer. These embodiments provide an optimum combination of sound dampening properties, impact resistance and ease of production.

A preferred embodiment of the first aspect of the invention is characterized in that the polymer binder in the intermediate layer is a thermosetting binder, more preferably selected from polyurethane, melamine formaldehyde, methylene diphenyl diisocyanate, urea formaldehyde and melamine urea formaldehyde.

These embodiments ensure good producibility of the decorative panels. The use of the thermosetting binder is advantageous for the adhesion of the decorative top layer to the intermediate layer. This is particularly important when the decorative top layer is laminated onto the intermediate layer using thermosetting resins (for example using melamine formaldehyde resin).

The use of a thermosetting binder as a polymer binder in the intermediate layer also ensures good impact resistance.

Polyurethane is preferred here as a polymer binder in the intermediate layer because of the even better sound dampening of such decorative panels.

A preferred embodiment of the first aspect of the invention, wherein the polymer binder of the intermediate layer is a thermosetting binder, is characterized in that the thermosetting binder accounts for less than 10% by weight of the intermediate layer.

The second aspect of the invention relates to a decorative panel, wherein the decorative panel comprises a decorative top layer and a carrier layer. The decorative panel of the second aspect of the invention is characterized in that the panel comprises an intermediate layer, wherein the intermediate layer is located between the decorative top layer and the carrier layer, wherein the intermediate layer comprises a first layer and a second layer, wherein the first layer is located between the second layer and the decorative top layer. The first layer comprises wood particles—either wood chips and/or wood fibres—and a thermosetting binder. The second layer comprises wood particles either wood chips and/or wood fibres-and a thermoplastic binder.

The presence of the intermediate layer with its specific composition ensures that less noise is generated when these panels used as floor panels are walked on. The presence of the thermoplastic binder in the second layer is especially important in this context.

The use of the thermosetting binder in the first layer of the intermediate layer is also advantageous for the adhesion of the decorative top layer to the intermediate layer. This is particularly important when the decorative top layer is laminated onto the intermediate layer using thermosetting resins (for example using melamine formaldehyde resin).

Because the thermoplastic binder is contained in the second layer—and not in the first layer, which comprises a thermosetting binder—the decorative panel can more easily be produced. Typically, layers that comprise wood particles are produced by scattering the materials. In such a production method, the first layer of the decorative panel according to the second aspect of the invention comes into contact with a continuous band. Because the second layer—which does not come into contact with the continuous band comprises the thermoplastic binder, there is no risk that this thermoplastic binder will adhere to the continuous band.

It is also possible to lightly sand the panel—on its first layer—before applying the decorative top layer in order to calibrate the board thickness. If the first layer were to contain the thermoplastic binder, there would be a risk that it would adhere due to the heat generated by the friction of this sanding.

A preferred embodiment of the second aspect of the invention is characterized in that the thickness of the intermediate layer is between 5 and 40% of the total thickness of the panel; more preferably, the thickness of the intermediate layer is between 20 and 40% of the total thickness of the panel.

These embodiments are advantageous in that the second layer is close to the decorative surface of the panel. This is favourable for the sound dampening properties of the decorative panel.

A preferred embodiment of the second aspect of the invention is characterized in that the thickness of the second layer of the intermediate layer is between 30 and 70% of the thickness of the intermediate layer, more preferably wherein the thickness of the second layer of the intermediate layer is between 40 and 60% of the thickness of the intermediate layer.

Such embodiments provide a good combination of sound dampening, mechanical properties and cost efficiency.

A preferred embodiment of the second aspect of the invention is characterized in that the decorative top layer is laminated onto the first layer.

These embodiments are advantageous in that the second layer is close to the decorative surface of the panel. This is favourable for the sound dampening properties of the decorative panel.

A preferred embodiment of the second aspect of the invention is characterized in that the thermosetting binder of the first layer is selected from polyurethane, melamine formaldehyde, methylene diphenyl diisocyanate, urea formaldehyde, melamine urea formaldehyde and hyperbranched polyamines (preferably bio-based hyperbranched polyamines).

Polyurethane is preferred here, because it provides decorative panels with an even better sound dampening effect when the panels are walked on.

A preferred embodiment of the second aspect of the invention is characterized in that the thermoplastic binder of the second layer is selected from polyvinyl butyral (PVB), polylactic acid (PLA) and ethylene vinyl acetate (EVA).

In addition to outstanding dampening, these thermoplastic binders ensure better water resistance of the decorative panels.

A preferred embodiment of the second aspect of the invention is characterized in that the second layer also comprises a thermosetting binder, preferably selected from polyurethane, melamine formaldehyde, methylene diphenyl diisocyanate, urea formaldehyde and melamine urea formaldehyde.

Such embodiments ensure an improved impact resistance of the decorative panels. Use of polyurethane is preferred here, because it is also beneficial for the sound dampening properties of the panel.

A preferred embodiment of the second aspect of the invention is characterized in that the second layer comprises low-density particles, wherein the low-density particles have a density of less than 0.35 g/cm³.

Such embodiments ensure that even less noise is produced when people walk on floor coverings composed of these decorative panels.

A preferred embodiment of the second aspect of the invention is characterized in that the low-density particles of the second layer have a density of less than 0.30 g/cm³.

Such embodiments ensure that even less noise is produced when people walk on floor coverings composed of these decorative panels.

A preferred embodiment of the second aspect of the invention is characterized in that the low-density particles of the second layer are selected from one or more of cork particles, polyurethane foam particles, thermoplastic foam particles or expanded glass.

A preferred embodiment of the second aspect of the invention is characterized in that the second layer comprises between 5 and 25% by weight—and preferably between 7.5 and 15% by weight—of low-density particles.

These embodiments provide very good sound dampening combined with good impact resistance of the decorative panels.

A preferred embodiment of the second aspect of the invention is characterized in that the low-density particles in the second layer have an apparent diameter of less than 2.5 mm, and preferably less than 2 mm. “Apparent diameter” refers to the diameter of a spherical shape that has the same volume as the particle, which does not necessarily have a spherical shape. Such embodiments are advantageous in that good sound dampening is combined with good impact resistance of the decorative panel.

Preferred embodiments both of the first aspect and of the second aspect of the invention are characterized in that the carrier layer is or comprises a fibreboard, a particle board or a mineral board—for example a cement fibreboard or a magnesium oxide board.

Carrier layers that are or comprise a fibreboard or a particle board are preferred. Recycling of such panels is easier, because the intermediate layer also comprises wood fibres and/or wood chips.

Preferred embodiments of both the first aspect and the second aspect of the invention are characterized in that the decorative top layer comprises at least one decor and a transparent or translucent wear layer.

Preferably, this wear layer comprises an acrylate resin, a methacrylate resin or a polyester resin. The use of such wear layers is advantageous in that the panels cause even less noise. The inventors assume that this is due to the softer cured resin, which reduces tapping noises when the panels are walked on with high-heeled shoes.

More preferably, the wear layer comprises wear-proof particles, for example corundum particles.

Preferably, the acrylate resin or the methacrylate resin or the polyester resin is completely or partially thermally cured; and/or the acrylate resin or the methacrylate resin or the polyester resin is completely or partially cured by means of UV radiation.

The combination of thermal curing with curing by UV radiation is particularly interesting, because this leads to optimum properties of the decorative top layer.

The type of curing can be determined in the decorative panel by the presence of thermal initiators when using thermal curing and by the presence of UV initiators when using curing with UV radiation.

Preferred embodiments of the first aspect or of the second aspect of the invention are characterized in that the decorative top layer comprises a decorative printed paper layer. Preferably, the printed paper layer is impregnated with a melamine resin or with an acrylate resin.

Preferred embodiments of both the first aspect and the second aspect of the invention are characterized in that the printed paper layer, on the side facing the intermediate layer and/or the side facing the wear layer, comprises an adhesion layer, preferably wherein the adhesion layer is or comprises a polyurethane adhesion layer.

These embodiments ensure advantageous properties in wear layers comprising an acrylate resin or a methacrylate resin or a polyester resin, because good adhesion is achieved between the printed paper layer and the wear layer.

Preferred embodiments of both the first aspect and the second aspect of the invention are characterized in that the decorative top layer comprises a decorative printed paper layer impregnated with a melamine resin, wherein the decorative top layer comprises a transparent or translucent wear layer; wherein the wear layer comprises a sheet of paper impregnated with melamine. Optionally, the wear layer comprises wear-proof particles, preferably corundum particles.

Preferred embodiments of both the first aspect and the second aspect of the invention are characterized in that the decorative top layer comprises a decorative print and in that the surface of the decorative panel comprises a texture, preferably wherein the texture is in register with the decorative print.

Preferably, at least a part of the texture extends into the intermediate layer. This is easier to carry out by warm pressing, because the intermediate layer is somewhat softer and more plastic.

Preferred embodiments of both the first aspect and the second aspect of the invention are characterized in that the carrier layer accounts for at least 50%—and more preferably at least 60%—of the thickness of the panel.

This means that the intermediate layer is located close to the decorative surface of the decorative panel. This is favourable for the sound dampening properties when floor coverings composed of such decorative panels are walked on.

Preferred embodiments of both the first aspect and the second aspect of the invention are characterized in that the panel comprises a balancing layer on its underside, preferably wherein the balancing layer comprises a resin-treated (e.g. with melamine resin) sheet of paper or is composed thereof; or wherein the balancing layer comprises a cork layer or is composed thereof.

This ensures better stability of the panel; it is also better for preventing noise when the floor coverings composed of these panels are walked on.

Preferred embodiments of both the first aspect and the second aspect of the invention are characterized in that the decorative top layer comes into contact with the intermediate layer.

This means that the intermediate layer is located close to the surface of the decorative panel. This is favourable for the sound dampening properties when floor panels composed of these decorative panels are walked on, because the intermediate layer is the layer primarily responsible for the sound dampening properties.

Preferred embodiments of both the first aspect and the second aspect of the invention are characterized in that the decorative panel is rectangular, either square or oblong, wherein the decorative panel is provided on at least two opposite edges with coupling means that allow two of such decorative panels to be coupled to each other at the respective edges, wherein, in the coupled state, locking is present in the direction perpendicular to the plane of the coupled panels and in the direction perpendicular to the coupled edges and in the plane of the coupled panels, wherein the coupling means comprise at least one male part in the form of a tongue, and wherein the coupling means comprise at least one female part in the form of a groove.

These embodiments allow the decorative panels to be correctly and quickly installed in a floor covering. Because the panels can be correctly installed, there is less risk of noise pollution when the panels are walked on.

Preferably, the groove is flanked by a lower lip and an upper lip.

Preferably, the coupling means are primarily configured as a tongue on the one hand and a groove delimited by an upper lip and a lower lip on the other hand, wherein this tongue and groove are primarily responsible for locking in the direction perpendicular to the plane of the coupled panels; and wherein the tongue and the groove are provided with additional locking parts, primarily responsible for locking in the direction perpendicular to the coupled edges and in the plane of the coupled panels; the locking parts preferably comprise a projection on the lower lip of the groove and a recess cooperating therewith on the underside of the tongue.

Stability of the installed panels is achieved by the locking in both directions. This is advantageous for preventing noise problems.

Preferably, the coupling means can be fit into each other by means of a rotating movement W. This ensures highly reliable installation of the panels.

Preferably, the coupling means are primarily configured in the carrier layer. Preferably, the coupling means are primarily configured of the material of the carrier layer.

These embodiments ensure that the coupling means are correctly configured; this is favourable for correct installation. This again ensures that noise problems are prevented. Because the coupling means are not configured in the intermediate layer, it remains intact. This is favourable for the sound dampening properties of the decorative panel.

In order to better explain the characteristics of the invention, the following is a description, by no means restrictive in nature, of several preferred embodiments with reference to the attached drawings, wherein:

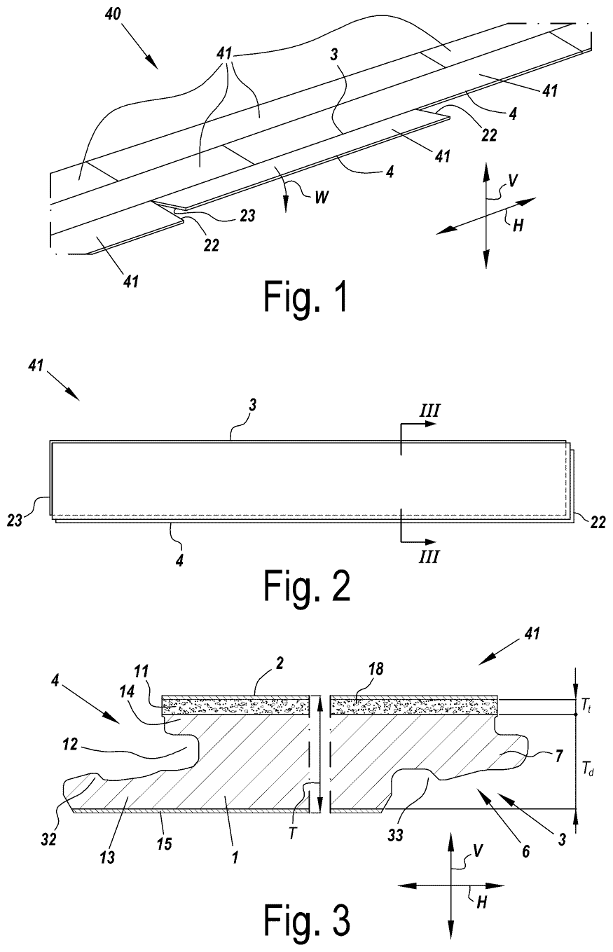

FIG. 1 shows a floor covering that comprises decorative panels according to the invention;

FIG. 2 shows a panel—according to an aspect of the invention—as used in the floor covering of FIG. 1;

FIG. 3 shows a section along III-III of the panel—according to an aspect of the invention—of FIG. 2;

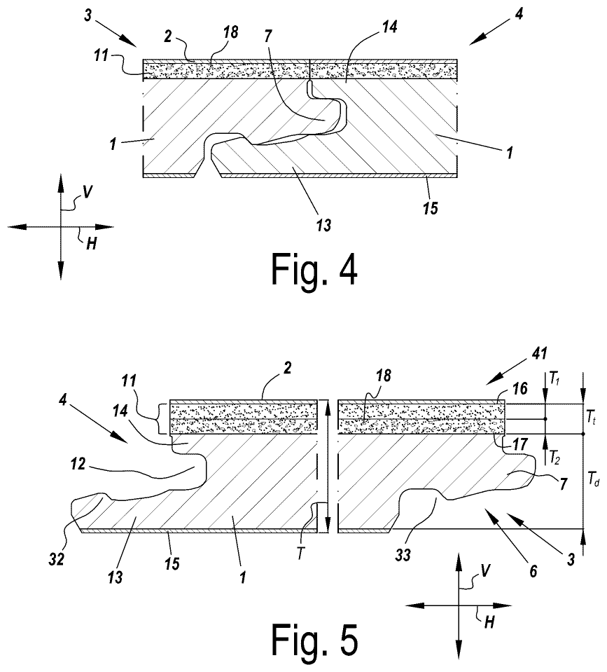

FIG. 4 shows two panels according to FIGS. 2 and 3 in a coupled state on their long edges; and

FIG. 5 shows a decorative panel according to an aspect of the invention in the same view as in FIG. 3.

FIG. 1 shows a floor covering 40 formed by decorative panels 41 according to the invention. The decorative panels 41 are coupled to one another at their first pair of opposite edges 3, 4 by means of their respective coupling means; and are also coupled to one another at their second pair of opposite edges 22, 23.

FIG. 2 shows a panel 41 as used in the floor covering of FIG. 1. The panel is oblong and rectangular and comprises at its long edges a first pair of opposite edges 3, 4 provided with coupling means. The short pair of opposite edges 22, 23 is also provided with coupling means. The coupling means 22, 23 at the short pair of opposite edges can be configured in a similar manner to the coupling means at the long edges. However, this is not necessarily the case for the invention.

FIGS. 3 and 4 show an example of a panel according to an aspect of the invention according to FIG. 2. FIG. 3 shows a section along III-III of the panel of FIG. 2. FIG. 4 shows two panels according to FIG. 2 coupled at their long edges 3, 4, i.e. at the edges illustrated in FIG. 3.

The panel 41 of FIGS. 2-4 comprises a carrier layer 1 and a decorative top layer 2 applied thereto. The panel comprises an intermediate layer 11 that is located between the decorative top layer 2 and the carrier layer 1. The intermediate layer comprises wood particles—in the example wood chips—, low-density particles 18 and a polymer binder. The low-density particles have a density of less than 0.35 g/cm³, and preferably less than 0.30 g/cm³. The polymer binder binds the wood particles and the low-density particles in the intermediate layer.

The carrier layer 1 of the example is composed of a fibreboard, preferably an HDF (high density fibreboard).

The decorative top layer 2 comes into contact with the intermediate layer 11.

The low-density particles 18 of the intermediate layer 11 can for example be cork particles, for example with a diameter of 1.5 mm. As an example, the intermediate layer can comprise 12% by weight of these cork particles.

In the example, the panel has a total thickness T of 10 mm. The carrier layer 1 has a thickness Td of 8 mm. The intermediate layer 11 has a thickness Tt of 2 mm.

In the example, the polymer binder of the intermediate layer is a thermoplastic binder, preferably selected from polyvinyl butyral (PVB), polylactic acid (PLA) and ethylene vinyl acetate (EVA).

However, the intermediate layer can also comprise a thermosetting binder instead of a thermoplastic binder or in combination with a thermoplastic binder.

The decorative panel can comprise a balancing layer 15 on its underside. This balancing layer can for example consist of a paper sheet impregnated with melamine resin that is laminated at the lower edge of the panel against the carrier layer 1.

The panel is provided at its two long opposite edges 3, 4 with coupling means that allow two such panels to be coupled to each other at the respective edges, wherein, in the coupled state, locking is present in the vertical direction V perpendicular to the plane of the coupled panels and in the horizontal direction H perpendicular to the coupled edges and in the plane of the coupled panels. This coupling can be carried out by means of a rotating movement W, as is shown in FIG. 1.

The coupling means of the one edge 3 of the two long opposite edges 3, 4 comprise one male part 6 in the form of a tongue 7; and at the other edge 4, one female part in the form of a groove 12. This groove is flanked by a lower lip 13 and an upper lip 14, wherein the lower lip comprises a locking element 32 and wherein the lower edge of the tongue 7 comprises a recess 33, wherein, in a coupled state of two such panels, the contact between the locking element 32 and the recess 33 provides locking of the coupled panels in the direction perpendicular to the edges 3, 4 coupled in this manner and parallel to the plane of the coupled panels.

The coupling means are configured in the carrier layer 1. The coupling means are configured of the material of the carrier layer 1.

In the example, the decorative top layer comprises a decorative printed paper layer impregnated with a melamine resin. The decorative top layer comprises a transparent wear layer. This wear layer comprises a sheet of paper impregnated with melamine. The wear layer comprises wear-proof particles, preferably corundum particles. The decorative decor layer further comprises a texture, in register with the decorative print. This texture extends at least partially into the intermediate layer.

Decorative top layers other than those given in this example are also possible.

FIG. 5 shows a decorative panel 41 according to an aspect of the invention in the same view as in FIG. 3. The panel comprises a decorative top layer 2, an intermediate layer 11 and a carrier layer 1. The intermediate layer 11 is located between the decorative top layer 2 and the carrier layer 1. The intermediate layer 11 comprises a first layer 16 and a second layer 17. The first layer 16 is located between the second layer 17 and the decorative top layer 2.

The first layer 16 comprises wood particles—in the example wood chips—and a thermosetting binder. The second layer 17 comprises wood particles—in the example wood chips—and a thermoplastic binder.

In the example of FIG. 5, the total thickness T of the panel is 12 mm. The thickness of the intermediate layer Tt is 4 mm. The second layer 17 has a thickness T2 of 2 mm. The first layer 16 has a thickness T1 equal to 2 mm. The carrier layer 1 has a thickness Td of 8 mm. Here, the thicknesses of the decorative top layer 2 and the balancing layer 15 are negligible.

The decorative top layer 2 is laminated onto the first layer 16.

The thermosetting binder of the first layer 16 is preferably selected from polyurethane, melamine formaldehyde, methylene diphenyl diisocyanate, urea formaldehyde, melamine urea formaldehyde and hyperbranched polyamines (preferably bio-based hyperbranched polyamines).

The thermoplastic binder of the second layer 17 is preferably selected from polyvinyl butyral (PVB), polylactic acid (PLA) and ethylene vinyl acetate (EVA).

Additionally, the second layer 17 can also comprise a thermosetting binder, preferably selected from polyurethane, melamine formaldehyde, methylene diphenyl diisocyanate, urea formaldehyde and melamine urea formaldehyde.

Optionally, the second layer 17 of the panel of FIG. 5 can comprise low-density particles 18, wherein the low-density particles have a density of less than 0.35 g/cm³ or even less than 0.30 g/cm³. These low-density particles 18 can be selected from one or more of cork particles, polyurethane foam particles, thermoplastic foam particles or expanded glass.

As is the case in the example of FIG. 3, the coupling means are configured in the carrier layer 1. Unlike in the example of FIG. 3, the coupling means are configured of the material of the carrier layer 1.

The reference numbers not specifically mentioned in the description of FIG. 5 have the same meaning as in FIG. 3.

The present invention is by no means limited to the embodiments described above; rather, such panels can be implemented according to different variants without departing from the scope of protection of the present invention.

1.-40. (canceled)

41. A decorative panel, wherein the panel comprises a decorative top layer and a carrier layer, wherein the panel comprises an intermediate layer;
wherein the intermediate layer is located between the decorative top layer and the carrier layer;
wherein the intermediate layer comprises wood particles; low-density particles and a polymer binder;
wherein the low-density particles have a density of less than 0.35 g/cm³,
wherein the wood particles are selected from wood chips, wood fibres, or a combination of wood chips and wood fibres;
wherein the polymer binder binds the wood particles and the low-density particles in the intermediate layer.

42. The decorative panel as in claim 41, wherein the low-density particles are selected from one or more of cork particles, polyurethane foam particles, thermoplastic foam particles or expanded glass.

43. The decorative panel as in claim 41, wherein the intermediate layer comprises between 5 and 25% by weight of low-density particles.

44. The decorative panel as in claim 41, wherein the low-density particles have an apparent diameter of less than 2.5 mm.

45. The decorative panel as in claim 41, wherein the polymer binder is a thermoplastic binder, selected from polyvinyl butyral (PVB), polylactic acid (PLA) and ethylene vinyl acetate (EVA).

46. The decorative panel as in claim 45, wherein the intermediate layer also comprises a thermosetting binder,
wherein the thermosetting binder is selected from polyurethane, melamine formaldehyde, methylene diphenyl diisocyanate, urea formaldehyde and melamine urea formaldehyde.

47. The decorative panel as in claim 46, wherein the thermosetting binder accounts for between 3 and 12% by weight of the intermediate layer.

48. The decorative panel as in claim 41, wherein the polymer binder is a thermosetting binder,
wherein the thermosetting binder is selected from polyurethane, melamine formaldehyde, methylene diphenyl diisocyanate, urea formaldehyde and melamine urea formaldehyde.

49. The decorative panel as in claim 48, wherein the thermosetting binder accounts for less than 10% by weight of the intermediate layer.

50. The decorative panel, wherein the panel comprises a decorative top layer and a carrier layer,
wherein the panel comprises an intermediate layer,
wherein the intermediate layer is located between the decorative top layer and the carrier layer;
wherein the intermediate layer comprises a first layer and a second layer,
wherein the first layer is located between the second layer and the decorative top layer;
wherein the first layer comprises wood particles; and a thermosetting binder;
wherein the wood particles of the first layer are selected from wood chips, wood fibres and combinations thereof;
wherein the second layer comprises wood particles and a thermoplastic binder;
wherein the wood particles of the second layer are selected from wood chips, wood fibres or combinations thereof.

51. The decorative panel as in claim 50, wherein the thickness of the intermediate layer is between 5 and 40% of the total thickness of the panel.

52. The decorative panel as in claim 50, wherein the thickness of the second layer of the intermediate layer is between 30 and 70% of the thickness of the intermediate layer.

53. The decorative panel as in claim 50, wherein the decorative top layer is laminated onto the first layer.

54. The decorative panel as in claim 50, wherein the thermosetting binder of the first layer is selected from polyurethane, melamine formaldehyde, methylene diphenyl diisocyanate, urea formaldehyde, melamine urea formaldehyde and hyperbranched polyamines.

55. The decorative panel as in claim 50, wherein the thermoplastic binder of the second layer is selected from polyvinyl butyral (PVB), polylactic acid (PLA) and ethylene vinyl acetate (EVA).

56. The decorative panel as in claim 55, wherein the second layer also comprises a thermosetting binder,
wherein the thermosetting binder is selected from polyurethane, melamine formaldehyde, methylene diphenyl diisocyanate, urea formaldehyde and melamine urea formaldehyde.

57. The decorative panel as in claim 50, wherein the second layer comprises low-density particles,
wherein the low-density particles have a density of less than 0.35 g/cm3.

58. The decorative panel as in claim 57, wherein the low-density particles are selected from one or more of cork particles, polyurethane foam particles, thermoplastic foam particles or expanded glass.

59. The decorative panel as in claim 57 wherein the second layer comprises between 5 and 25% by weight of low-density particles.

60. The decorative panel as in claim 57, wherein the low-density particles in the second layer have an apparent diameter of less than 2.5 mm.
